(19) United States
(12) Patent Application Publication
(10) Pub. No.: US 2014/0141225 A1
(43) Pub. Date: May 22, 2014

(54) POROUS SUPPORT LAYER

(71) Applicant: Saint-Gobain, (unknown)

(72) Inventors: Nathalie R. PETIGNY, CAVAILLON (FR); Christos SARANTOPOULOS, CAVAILLON (FR)

(73) Assignee: Saint-Gobain

(21) Appl. No.: 14/075,750

(22) Filed: Nov. 8, 2013

Related U.S. Application Data
(63) Continuation-in-part of application No. 13/671,835, filed on Nov. 8, 2012, now abandoned.
Application No. 13/671,835 is a continuation-in-part of application No. 13/672,975, filed on Nov. 9, 2012.

(51) Int. Cl. B01J 41/10

(52) U.S. Cl. CPC B01J 41/10
USPC 428/220; 252/184; 428/316.6; 427/243

(57) ABSTRACT

A porous support layer for a composite oxygen transport membrane has a high permeability, high porosity, and a microstructure exhibiting substantially uniform pore size distribution as a result of using bi-modal particle size distribution of the porous support layer materials.

### CROSS REFERENCE TO RELATED APPLICATIONS

The present application is a continuation-in part application of U.S. patent application Ser. No. 13/671,835, filed on Nov. 8, 2012, and U.S. patent application Ser. No. 13/672,975, filed on Nov. 9, 2012, which are incorporated by reference herein in their entireties.

### U.S. GOVERNMENT RIGHTS

The invention disclosed and claimed herein was made with United States Government support under Cooperative Agreement number DE-FC26-07NT43088 awarded by the U.S. Department of Energy. The United States Government has certain rights in this invention.

### FIELD OF THE INVENTION

The present invention relates to a porous support layer for a composite oxygen transport membrane and to a composite oxygen transport membrane and processes of forming the same.

### BACKGROUND

Oxygen transport membranes function by transporting oxygen ions through a material that is capable of conducting oxygen ions and electrons at elevated temperatures. Such materials can be mixed conducting in that they conduct both oxygen ions and electrons or a mixture of materials that include an ionic conductor capable of primarily conducting oxygen ions and an electronic conductor with the primary function of transporting the electrons. Typical mixed conductors are formed from doped perovskite structured materials. In case of a mixture of materials, the ionic conductor can be yttrium or scandium stabilized zirconia, and the electronic conductor can be a perovskite structured material that will transport electrons, a metal or metal alloy or a mixture of the perovskite type material, the metal or metal alloy.

When a partial pressure difference of oxygen is applied on opposite sides of such a membrane, oxygen ions will ionize on one surface of the membrane and emerge on the opposite side of the membrane and recombine into elemental oxygen. The free electrons resulting from the combination will be transported back through the membrane to ionize the oxygen. The partial pressure difference can be produced by providing the oxygen-containing feed to the membrane at a positive pressure or by supplying a combustible substance to the side of the membrane opposing the oxygen-containing feed or a combination of the two methods.

Typically, oxygen transport membranes are composite structures that include a dense layer composed of the mixed conductor or the two phases of materials and one or more porous supporting layers. Since the resistance to oxygen ion transport is dependent on the thickness of the membrane, the dense layer is made as thin as possible and therefore must be supported. Another limiting factor to the performance of an oxygen transport membrane concerns the supporting layers that, although can be active, that is oxygen ion or electron conducting, the layers themselves can consist of a network of interconnected pores that can limit diffusion of the oxygen or fuel or other substance through the membrane to react with the oxygen. Therefore, such support layers are typically fabricated with a graded porosity in which the pore size decreases in a direction taken towards the dense layer or are made highly porous throughout. The high porosity, however, tends to weaken such a structure.

U.S. Pat. No. 7,229,537 attempts to solve such problems by providing a support with cylindrical or conical pores that are not connected and an intermediate porous layer located between the dense layer and the support that distributes the oxygen to the pores within the support. Porous supports can also be made by freeze casting techniques, as described in 10, No. 3, Advanced Engineering Materials, “Freeze-Casting of Porous Ceramics: A Review of Current Achievements and Issues” (2008) by Deville, pp. 155-169. In freeze casting, a liquid suspension is frozen. The frozen liquid phase is then sublimated from a solid to a vapor under reduced pressure. The resulting structure is sintered to consolidate and densify the structure. This leads to a porous structure having pores extending in one direction and that have a low tortuosity. Such supports have been used to form electrode layers in solid oxide fuel cells. In addition to the porous support layers, a porous surface exchange layer can be located on the opposite side of the dense layer to enhance reduction of the oxygen into oxygen ions. Such a composite membrane is illustrated in U.S. Pat. No. 7,556,676 that utilizes two phase materials for the dense layer, the porous surface exchange layer and the intermediate porous layer. These layers are supported on a porous support that can be formed of zirconia.

As mentioned above, the oxygen partial pressure difference can be created by combusting a fuel or other combustible substance with the separated oxygen. The resulting heat will heat the oxygen transport membrane up to operational temperature and excess heat can be used for other purposes, for example, heating a fluid, for example, raising steam in a boiler or in the combustible substance itself. While perovskite structured materials will exhibit a high oxygen flux, such materials tend to be very fragile under operational conditions such as in the heating of a fluid. This is because the perovskite type materials will have a variable stoichiometry with respect to oxygen. In air it will have one value, and in the presence of a fuel that is undergoing combustion it will have another value. The end result is that at the fuel side, the material will tend to expand relative to the air side, and a dense layer will therefore, tend to fracture. In order to overcome this problem, a mixture of materials can be used in which an ionic conductor is provided to conduct the oxygen ions, and an electronic conductor is used to conduct the electrons. Where the ionic conductor is a fluorite structured material, this chemical expansion is restrained, and therefore, the membrane will be less susceptible to structural failure. However, the problem with the use of a fluorite structure material, such as a stabilized zirconia, is that such a material has lower oxygen ion conductivity. As a result, far more oxygen transport membrane elements are required for such a dual phase type of membrane as compared with one that is formed from a single phase perovskite type material.

### SUMMARY

A porous support layer can comprise a fluorite structured ionic conducting material having a porosity of greater than 20 percent and a microstructure exhibiting substantially uniform pore size distribution throughout the porous support layer, wherein the porous support layer is formed from a mixture comprising fluorite structured ionic conducting material have bi-modal or multi-modal particle sizes or from a mixture comprising polymethyl methacrylate based pore forming material and a fluorite structured ionic conducting material, the polymethyl methacrylate based pore forming material, the fluorite structured ionic conducting material, or both have bi-modal or multi-modal particle sizes.

In an embodiment, a composite oxygen transport membrane can comprise (i) the above described porous support layer; (ii) an intermediate porous layer, often referred to as a fuel oxidation layer, disposed adjacent to the porous support layer and capable of conducting oxygen ions and electrons to separate oxygen from an oxygen-containing feed and comprising a mixture of a fluorite structured ionic conductive material and electrically conductive materials to conduct the oxygen ions and electrons, respectively; (iii) a dense separation layer capable of conducting oxygen ions and electrons to separate oxygen from an oxygen-containing feed, the dense layer adjacent to the intermediate porous layer and also comprising a mixture of a fluorite structured ionic conductive material and electrically conductive materials to conduct the oxygen ions and electrons, respectively; and (iv) catalyst particles or a solution containing precursors of the catalyst particles located in pores of the porous support layer and intermediate porous layer, the catalyst particles containing a catalyst selected to promote oxidation of a combustible substance in the presence of the separated oxygen transported through the dense layer and the intermediate porous layer to the porous support layer. The catalyst can include gadolinium doped ceria but may also be other catalysts that promote fuel oxidation. The composite oxygen transport membrane may also include a porous surface exchange layer or an air activation layer disposed or applied to the dense separation layer on the side opposite to the intermediate porous layer or the fuel oxidation layer. If used, the porous surface exchange layer or an air activation layer can have a thickness of between 10 microns and 40 microns and a porosity of between about 30 percent and 60 percent.

The intermediate porous layer or fuel oxidation layer can have a thickness of between about 10 microns and 40 microns and a porosity of between about 20 percent and 50 percent whereas the dense layer has a thickness of between 10 microns and 50 microns. In one embodiment, the intermediate porous layer can be a he porous support layer is formed from a mixture comprising fluorite structured ionic conducting material having a bi-modal or multimodal particle size distribution and optionally a pore forming material. The fluorite structured ionic conducting material can be a stabilized zirconia, in particular a yttria stabilized zirconia, more particularly zirconia comprising at least 2mol % of yttrium oxide, such as from 2 mol % to 5 mol % of yttrium oxide, or from 3 mol % to 4 mol % of yttrium oxide. It is understood that “stabilized zirconia” also includes “partially stabilized zirconia”. The porous support layer may be formed from a mixture comprising 3 mol % yttria stabilized zirconia (“3YSZ”) having a bi-modal or multimodal particle size distribution or a mixture comprising 3YSZ and a pore forming material, wherein the 3YSZ, pore forming material, or both have a bi-modal or multimodal particle size distribution. The pore forming material may be a polymethyl methacrylate based pore forming material. In a particular embodiment, the fluorite structured ionic conducting material having bi-modal or multi-modal particle sizes comprises at least 30 weight percent of particles having a particle size greater than 2 microns and/or at least 90 weight percent of particles having a particle size below 10 microns, and in particular below 8 microns or even below 7 microns. Such a material may be obtained my mixing at least two powders having different median particle sizes. In one embodiment, the porous support layer is formed by mixing a first powder having a median particle size diameter (“D₅₀”) of between 0.3 microns and 1.5 microns and at least a second powder having a D₅₀ of between 2.0 microns and 6.0 microns. In one other embodiment, the porous support layer is formed from a fluorite structured ionic conducting material and polymethyl methacrylate based pore forming material having a bi-modal or multimodal particle size distribution. In any or all embodiments, the porous support layer can have a thickness of between about 0.5 mm and 4 mm and porosity between about 20 percent and 40 percent.

Broadly characterizing particular embodiments of the composite oxygen transport membrane, the intermediate porous layer comprises a mixture of about 60 percent by weight of (LaᵤSrᵥCe₁₋ᵤ₋ᵥ)_{w}CrₓM_{y}V_{z}O_{3-δ} with the remainder Zr_{x′}Sc_{y′}A_{x′}O_{2-δ}. As used herein, the variable “δ” as used in the formulas set forth below for the indicated substances, as would be known in the art would have a value that would render such substances charge neutral. Similarly, the dense separation layer comprises a mixture of about 40 percent by weight of (LaᵤSrᵥCe₁₋ᵤ₋ᵥ)_{w}CrₓM_{y}V_{z}O_{3-δ} with the remainder Zr_{x′}Sc_{y′}A_{z′}O_{2-δ}. In the above formulations, u is from 0.7 to 0.9, v is from 0.1 to 0.3, (1-u-v) is greater than or equal to zero, w is from 0.94 to 1, x is from 0.5 to 0.77, M is Mn or Fe, y is from 0.2 to 0.5, z is from 0 to 0.03, and x+y+z=1, where y′ is from 0.08 to 0.3, z′ is from 0.01 to 0.03, x′+y′+z′=1, and A is Y or Ce or a mixture of Y and Ce. The porous surface exchange layer or air activation layer, if employed, can be is formed from a mixture of about 50 percent by weight of (La_{x′″}Sr_{1-x′″})_{y′″}MO_{3-δ}, where x″′ is from 0.2 to 0.9, y″′ is from 0.95 to 1, M is Mn or Fe, with the remainder Zrₓ^{iv}Sc_{y}^{iv}A_{z}^{iv}O_{2-δ}, where y^{iv} is from 0.08 to 0.3, z^{iv} is from 0.01 to 0.03, x^{iv}+y^{iv}+z^{iv}=1, and A is Y, Ce or mixtures thereof.

More specifically, a particular embodiment of the composite oxygen transport membrane includes an intermediate porous layer or fuel oxidation layer that comprises about 60 percent by weight of (La_{0.825}Sr_{0.175})_{0.96}Cr_{0.76}Fe_{0.225}V_{0.015}O_{3-δ} or (La_{0.8}Sr_{0.2})_{0.95}Cr_{0.7}Fe_{0.3})_{3-δ} with the remainder stabilized zirconia with 10 mol % Sc and 1 mol % Y (10Sc1YSZ) or stabilized zirconia with 10 mol % Sc and 1 mol % Ce (10Sc1CeSZ). Similarly, the dense separation layer comprises about 40 percent by weight of (La_{0.825}Sr_{0.175})_{0.94}Cr_{0.72}Mn_{0.26}V_{0.02}O_{3-δ} or (La_{0.8}Sr_{0.2})_{0.05}Cr_{0.5}Fe_{0.5}O_{3-δ}, with the remainder 10Sc1YSZ or 10Sc1CeYSZ. The porous surface exchange layer or air activation layer is formed from a mixture of about 50 percent by weight of (La_{0.8}Sr_{0.2})_{0.98}MnO_{3-δ} or La_{0.8}Sr_{0.2}FeO_{3-δ}, with the remainder 10Sc1YSZ or 10Sc1CeSZ.

The porous support layer can be formed by a process comprising: (i) fabricating a porous support layer comprising a fluorite structured ionic conducting material, the fabricating step including pore forming enhancement step such that the porous support layer has a porosity of greater than about 20 percent and a microstructure exhibiting substantially uniform pore size distribution throughout the porous support layer.

A composite oxygen transport membrane can be formed by a process comprising: (i) fabricating a porous support layer comprised of a fluorite structured ionic conducting material, the fabricating step including pore forming enhancement step such that the porous support layer has a porosity of greater than about 20 percent and a microstructure exhibiting substantially uniform pore size distribution throughout the porous support layer; (ii) applying an intermediate porous layer or fuel oxidation layer on the porous support layer, (iii) applying a dense separation layer on the intermediate porous layer; and (iv) introducing catalyst particles or a solution containing precursors of the catalyst particles to the porous support layer and intermediate porous layer, the catalyst particles containing a catalyst selected to promote oxidation of a combustible substance in the presence of the separated oxygen transported through the dense layer and the intermediate porous layer to the porous support layer.

Both the intermediate porous layer and dense separation layer are capable of conducting oxygen ions and electrons to separate oxygen from an oxygen-containing feed. Both layers comprise a mixture of a fluorite structured ionic conductive material and an electrically conductive material to conduct the oxygen ions and electrons, respectively.

The pore forming enhancement process involves several alternative techniques including mixing a polymethyl methacrylate-based pore forming material with the fluorite structured ionic conducting material of the porous support layer. In addition or alternatively, the pore forming enhancement process may further involve use of bi-modal or multi-modal particle sizes of the polymethyl methacrylate based pore forming material, the fluorite structured ionic conducting material, or both materials of the porous support layer.

The step of introducing catalyst particles or a solution containing precursors of the catalyst particles to the porous support layer and intermediate porous layer may further comprise either: (a) adding catalyst particles directly to the mixture of materials used in the intermediate porous layer; or (b) applying a solution containing catalyst precursors to the porous support layer on a side thereof opposite to the intermediate porous layer so that the solution infiltrates or impregnates pores within the porous support layer and the intermediate porous layer with the solution containing catalyst precursors, and heating the composite oxygen transport membrane after the solution containing catalyst precursors infiltrates such pores and to form the catalyst from the catalyst precursors.

Finally, a method of producing a catalyst-containing composite oxygen transport membrane can comprise the steps of: (i) forming a composite oxygen transport membrane in a sintered state, the composite oxygen transport membrane having a plurality of layers comprising a dense separation layer, a porous support layer, and an intermediate porous layer (i.e., fuel oxidation layer) located between the dense separation layer and the porous support layer; (ii) applying a solution containing catalyst precursors to the porous support layer on a side thereof opposite to the intermediate porous layer, the catalyst precursors selected to produce a catalyst capable of promoting oxidation of the combustible substance in the presence of the separated oxygen; (iii) infiltrating or impregnating the porous support layer with the solution so that the solution wicks through pores of the porous support layer and at least partially infiltrates or impregnates the intermediate porous layer, and (iv) heating the composite oxygen transport membrane after infiltrating such pores within the porous support layer and the intermediate porous layer such that the catalyst is formed from the catalyst precursors. In a particular embodiment, the catalyst includes a gadolinium doped ceria, and the solution is an aqueous metal ion solution containing about 20 mol % Gd(NO₃)₃ and 80 mol % Ce(NO₃)₃ that when sintered forms Gd_{0.8}Ce_{0.2}O_{2-δ}.

Each of the dense layer and the intermediate porous layer is capable of conducting oxygen ions and electrons at an elevated operational temperature to separate oxygen from an oxygen-containing feed. The dense layer and the intermediate porous layer comprise mixtures of a fluorite structured ionic conductive material and electrically conductive materials to conduct oxygen ions and electrons, respectively.

The porous support layer comprises a fluorite structured ionic conducting material having a porosity of greater than about 20 percent and a microstructure exhibiting substantially uniform pore size distribution throughout the porous support layer. Pores are formed within the porous support layer using bi-modal or multi-modal particle sizes of the polymethyl methacrylate-based pore forming material, the fluorite structured ionic conducting material, or both materials of the porous support layer.

To aid in the infiltration or impregnation process, a pressure may be established on the second side of the porous support layer, or the pores of the porous support layer and fuel oxidation layer may first be evacuated of air using a vacuum to further assist in wicking of the solution to reduce the likelihood of trapped air in the pores preventing wicking of the solution all the way through the support structure to the intermediate layer.

### BRIEF DESCRIPTION OF THE DRAWINGS

While the specification concludes with claims distinctly pointing out the subject matter that Applicants regard as their invention, it is believed that the invention will be better understood when taken in connection with the accompanying drawings in which:

FIG. 1 is a cross-sectional schematic view of a composite oxygen transport membrane element that is fabricated in accordance with an embodiment of the present invention;

FIG. 2 is an alternative embodiment of FIG. 1;

FIG. 3 is an alternative embodiment of FIG. 1;

FIG. 4 is a scanning electron microscope (SEM) micrograph image at 1000× magnification showing a porous support layer comprised of 3YSZ with walnut shells as the pore forming material;

FIG. 5 is an SEM micrograph image at 1000× magnification showing a porous support layer comprised of 3YSZ with a polymethyl methacrylate based pore forming material in accordance with an embodiment of the present invention;

FIG. 6 is another SEM micrograph image at 2000× magnification showing a porous support layer comprised of 3YSZ with a polymethyl methacrylate based pore forming material in accordance with an embodiment the present invention; and

FIG. 7 is an SEM micrograph image at 2000× magnification showing a porous support layer comprising 3YSZ with multi-modal particle sizes in accordance with an embodiment of the present invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes, ” “including, ” “has, ” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the solid oxide fuel cell arts.

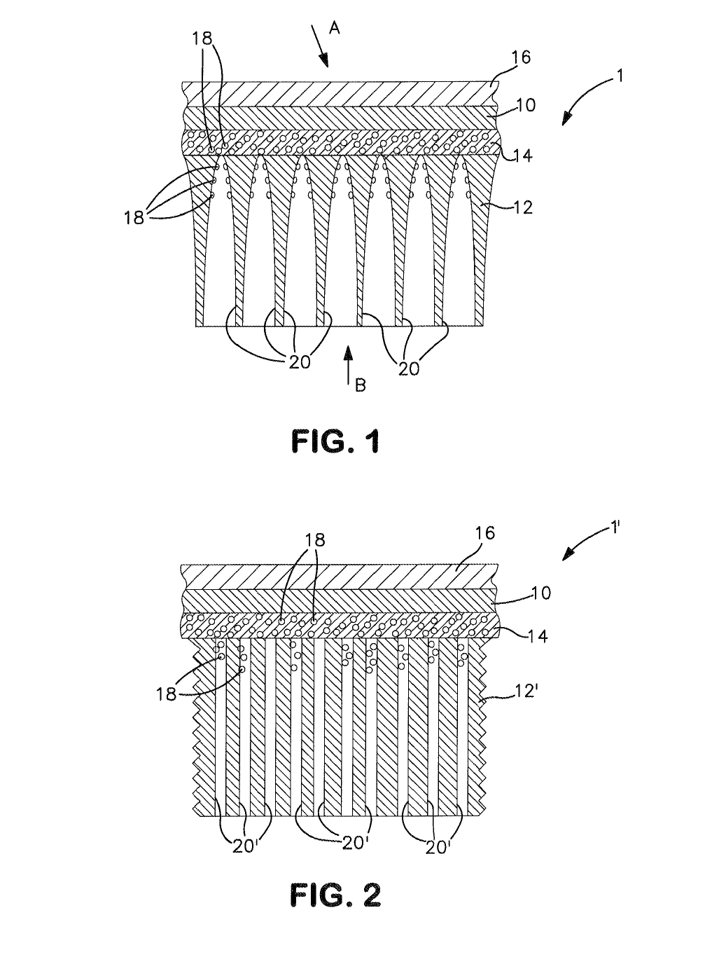

With reference to FIG. 1, a sectional view of a composite oxygen transport membrane element 1 in accordance with an embodiment is illustrated. As could be appreciated by those skilled in the art, such composite oxygen transport membrane element 1 could be in the form of a tube or a flat plate. Such composite oxygen transport membrane element 1 would be one of a series of such elements situated within a device to heat a fluid such as in a boiler or other reactor having such a heating requirement.

Composite oxygen transport membrane element 1 is provided with a dense layer 10, a porous support layer 12, and an intermediate porous layer 14 located between the dense layer 10 and the porous support layer 12. A preferable option is, as illustrated, to also include a porous surface exchange layer 16 in contact with the dense layer 10, opposite to the intermediate porous layer 14. Catalyst particles 18 are located in the intermediate porous layer 14 that are formed of a catalyst selected to promote oxidation of a combustible substance in the presence of oxygen separated by the composite membrane element 1. It is to be noted that the term “combustible substance” as used herein means any substance that is capable of being oxidized, including to a fuel in case of a boiler, a hydrocarbon-containing substance for purposes of oxidizing such substance for producing a hydrogen and carbon monoxide containing synthesis gas or the synthesis gas itself for purposes of supplying heat to, for example, a reformer. As such the term, “oxidizing” as used herein encompasses both partial and full oxidation of the substance.

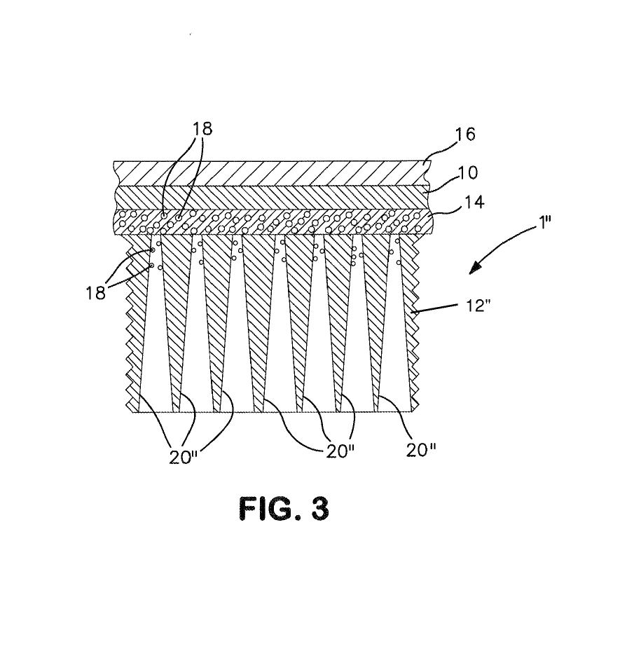

Operationally, air or other oxygen-containing fluid is contacted on one side of the composite oxygen transport membrane element 1, and more specifically, against the porous surface exchange layer 16 in the direction of arrowhead “A”. The porous surface exchange layer 16 is porous and is capable of mixed conduction of oxygen ions and electrons and functions to ionize some of the oxygen. The oxygen that is not ionized at and within the porous surface exchange layer 16, similarly, also ionizes at the adjacent surface of the dense layer 10 which is also capable of such mixed conduction of oxygen ions and electrons. The oxygen ions are transported through the dense layer 10 to intermediate porous layer 14 to be distributed to pores 20 of the porous support layer 12. It should be noted that in FIGS. 1-3, the pores 20 within the porous support layer 12, 12′, 12″ are shown in an exaggerated manner. Some of the oxygen ions, upon passage through the dense layer 10 will recombine into elemental oxygen. The recombination of the oxygen ions into elemental oxygen is accompanied by the loss of electrons that flow back through the dense layer 10 to ionize the oxygen at the opposite surface thereof.

At the same time, a combustible substance, for example a hydrogen and carbon monoxide containing synthesis gas, is contacted on one side of the porous support layer 12, 12′, 12″ located opposite to the intermediate porous layer 14 as indicated by arrowhead “B”. The combustible substance enters pores 20, contacts the oxygen and burns through combustion supported by oxygen. The combustion is promoted by the catalyst that is present by way of catalyst particles 18.

The presence of combustible fuel on the side of the composite oxygen ion transport membrane element 1, specifically the side of the dense layer 10 located adjacent to the intermediate porous layer 14 provides a lower partial pressure of oxygen. This lower partial pressure drives the oxygen ion transport as discussed above and also generates heat to heat the dense layer 10, the intermediate porous layer 14 and the porous surface exchange layer 16 up to an operational temperature at which the oxygen ions will be conducted. In specific applications, the incoming oxygen-containing stream can also be pressurized to enhance the oxygen partial pressure difference between opposite sides of the composite oxygen ion transport membrane element 1. Excess heat that is generated by combustion of the combustible substance will be used in the specific application, for example, the heating of water into steam within a boiler or to meet the heating requirements for other endothermic reactions.

In the embodiments described with reference to FIGS. 1-3, the use of a single phase mixed conducting material such as a perovskite structured materials has the disadvantage of exhibiting chemical expansion, or in other words, one side of a layer, at which the oxygen ions recombine into elemental oxygen, will expand relative to the opposite side thereof. This resulting stress can cause failure of such a layer or separation of the layer from adjacent layers. In order to avoid this, the dense layer, the intermediate porous layer, and the porous surface exchange layer can be all formed of a two phase system comprising a fluorite structured material in one phase as the ionic conductor of the oxygen ions and an electronic conducting phase that in the illustrated embodiment is a perovskite type material. In the described embodiments, the porous support layer 12, 12′, 12″ has a thickness of between about 0.5 mm and about 4.0 mm, and more particularly about 1.0 mm, and in a particular embodiment, can be formed only of a fluorite structured material or of a fluorite structured material only with a polymethyl methacrylate (“PMMA”) based pore former material. As such, the porous support layer 12, 12,′ 12″ may not exhibit significant mixed conduction. The material used in forming the porous support layer can have a thermal expansion coefficient in the range 9×10⁻⁶ cm/cm×K⁻¹ and 12×10⁻⁶ cm/cm×K⁻¹ in the temperature range of 20° C. to 1000° C.; where “K” is the temperature in Kelvin.

As discussed above, dense layer 10 or dense separation layers function to separate oxygen from an oxygen-containing feed exposed to one surface of the oxygen ion transport membrane 10 and contains an electronic and ionic conducting phases. The dense separation layer also serves as a barrier of sorts to substantially prevent mixing of the fuel on one side of the membrane with the air or oxygen-containing feed stream on the other side of the membrane. In a particular embodiment, the electronic phase in the dense layer is (LaᵤSrᵥCe₁₋ᵤ₋ᵥ)_{w}CrₓM_{y}V_{z}O_{3-δ} where u is from about 0.7 to about 0.9, v is from about 0.1 to about 0.3 and (1-u-v) is greater than or equal to zero, w is from about 0.94 to about 1, x is from about 0.5 to about 0.77, M is Mn or Fe, y is from about 0.2 to about 0.5, z is from about 0 to about 0.03, and x+y+z=1 (“LSCMV”). The ionic phase is Zr_{x′}Sc_{y′}A_{z′}O_{2-δ} (“YScZ”), where y′ is from about 0.08 to about 0.3, z′ is from about 0.01 to about 0.03, x′+y′+z′=1, and A is Y or Ce or mixtures of Y and Ce. It is to be noted, that since the quantity (1-u-v) can be equal to zero, cerium may not be present within an electronic phase of an embodiment. The dense separation layer can contain a mixture of 40 percent by weight (La_{0.8}Sr_{0.2})_{0.95}Cr_{0.5}Fe_{0.5}O_{3-δ}, with the remainder 10Sc1CeYSZ; or alternatively about 40 percent by weight of (La_{0.825}Sr_{0.175})_{0.94}Cr_{0.72}Mn_{0.26}V_{0.02}O_{3-δ}, with the remainder 10Sc1YSZ. As also mentioned above, in order to reduce the resistance to oxygen ion transport, the dense layer should be made as thin as possible and in the described embodiment has a thickness of between about 10 microns and about 50 microns.

The porous surface exchange layer 16 or air activation layers are designed to enhance the surface exchange rate by enhancing the surface area of the dense layer 10 while providing a path for the resulting oxygen ions to diffuse through the mixed conducting oxide phase to the dense layer 10 and for oxygen molecules to diffuse through the open pore spaces to the same. The porous surface exchange layer 16 therefore, reduces the loss of driving force in the surface exchange process and thereby increases the achievable oxygen flux. As indicated above, it also can be a two-phase mixture containing an electronic conductor composed of (La_{x′″}Sr_{1-x′″})_{y′″}MO_{3-δ}, where x″′ is from about 0.2 to about 0.9, y″′ is from about 0.95 to 1, and M is Mn or Fe; and an ionic conductor composed of Zrₓ^{iv}Sc_{y}^{iv}A_{z}^{iv}O_{2-δ}, where y^{iv} is from about 0.08 to about 0.3, z^{iv} is from about 0.01 to about 0.03, x^{iv}+y^{iv}+z^{iv}=1, and A is Y, Ce or mixtures of Y and Ce. In the described embodiments, the porous surface exchange layer 16 is formed from a mixture of about 50 percent by weight of (La_{0.8}Sr_{0.2})_{0.98}MnO_{3-δ}, with the remainder 10Sc1YSZ. The porous surface exchange layer 16 is a porous layer and can have a thickness of between about 10 microns and about 40 microns, a porosity of between about 30 percent and about 60 percent and an average pore diameter of between about 1 microns and about 4 microns.

The intermediate porous layer 14 is a fuel oxidation layer and can be formed of the same mixture as the dense layer 10 and can have an applied thickness of between about 10 microns and about 40 microns, a porosity of between about 25 percent and about 40 percent and an average pore diameter of between about 0.5 microns and about 3 microns.

In addition, incorporated within the intermediate porous layer 14 are catalyst particles 18. The catalyst particles 18 in the described embodiments can be a gadolinium doped ceria (“CGO”) that have a size of between about 0.1 and about 1 microns. In a particular embodiment, the intermediate porous layers contain a mixture of about 60 percent by weight of (La_{0.825}Sr_{0.175})_{0.96}Cr_{0.76}Fe_{0.225}V_{0.015}O_{3-δ}, with the remainder 10Sc1YSZ. It is to be noted that intermediate porous layer 14 as compared with the dense layer 10 may contain iron in addition to or in place of manganese, a lower A-site deficiency, a lower transition metal (iron) content on the B-site, a slightly lower concentration of vanadium on the B-site, or any combination thereof. It has been found that the presence of iron in the intermediate porous layer 14 aids the combustion process, and that the presence of manganese at higher concentration and a higher A-site deficiency in the dense layer 10 improves electronic conductivity and sintering kinetics. If needed, a higher concentration of vanadium may be present in the dense layer 10 because vanadium functions as a sintering aid and helps to promote densification of the dense layer 10. Vanadium, if any, is used in lesser extent in the intermediate porous layer 14 in order to match the shrinkage and thermal expansion characteristics with the dense layer 10.

The porous support layer 12, 12′, 12″ can be formed from a previously described mixture by known forming techniques including extrusion techniques and freeze casting techniques. Although pores 20, 20′, 20″ in the porous support layer 12, 12′, 12″ are indicated as being a regular network of non-interconnected pores, in fact there exists some degree of connection between pores towards the intermediate porous layer 14. In any event, the porous network and microstructure of the porous support layer 12, 12′, 12″ may be controlled so as to promote or optimize the diffusion of the combustible substance to the intermediate porous layer 14 and the flow of combustion products such as steam and carbon dioxide from the pores in a direction opposite to that of arrowhead “B”. The porosity of porous support layers 12, 12′, 12″ can be greater than about 20 percent for the described embodiment as well as other possible embodiments.

The porous support layers 12, 12′, 12″ are possibly fabricated from 3YSZ material commercially available from various suppliers including Tosoh Corporation and its affiliates, including Tosoh USA, with an address at 3600 Gantz Road, Grove City, Ohio. Advancements in the performance of the porous support layers have been realized when using 3YSZ with multi-modal particle sizes. Optionally, the 3YSZ could be combined with fugitive organic pore former materials, specifically PMMA. In the particular embodiments, the porous support layer 12, 12′, 12″ can be fabricated from 67 wt % 3YSZ mixed together with 33 wt % of a PMMA based pore forming material. When added, the pore forming material can be a mixture comprising 30 wt % carbon black with an average particle size less than or equal to about 1 micron combined with 70 wt % PMMA pore formers having a narrow particle size distribution and an average particle size of between about 0.8 microns and 5.0 microns. Although use of the PMMA pore formers with a narrow particle size distribution have shown promising results, further pore optimization and microstructure optimization may be realized using hollow, spherical particles as well as bi-modal or multi-modal particle size distributions of either or both of the 3YSZ materials and the PMMA based pore formers. For example, bi-modal or multimodal particle size distribution of PMMA pore formers, including PMMA particles with average particle diameters of 0.8 microns, 1.5 microns, 3.0 microns, and 5.0 microns are contemplated.

As described in more detail below, a particular fabrication process of the oxygen transport membrane is to form the porous support via an extrusion process and subsequently bisque firing of the extruded porous support. The porous support is then coated with the active membrane layers, including the intermediate porous layer and the dense layer, after which the coated porous support assembly is dried and fired. The coated porous support assembly is then co-sintered at a final optimized sintering temperature and conditions.

A significant aspect or characteristic of the materials or combination of materials selected for the porous support is its ability to mitigate creep while providing enough strength to be used in the oxygen transport membrane applications, which can reach temperatures above 1000° C. and very high loads. Porous support materials are selected so that when sintered, such materials will demonstrate shrinkages that match or closely approximate the shrinkage of the other layers of the oxygen transport membrane, including the dense separation layer, and intermediate porous layer 14.

In a particular embodiment, the sintering temperature and conditions are selected so as to match or closely approximate the shrinkage profiles of the porous support to the shrinkage profiles of the dense separation layer while reducing any chemical interaction between the materials of the active membrane layers, the materials in the porous support layer, and the sintering atmosphere. Too high of a sintering temperature tends to promote unwanted chemical interactions between the membrane materials, the porous support, and surrounding sintering atmosphere. Reducing atmospheres during sintering using blends of hydrogen and nitrogen gas atmosphere can be used to reduce unwanted chemical reactions but tend to be more costly techniques compared to sintering in air. Thus, an advantage to the oxygen transport membrane of the disclosed embodiments is that some may be fully sintered in air. For example, a dense separation layer comprising (La_{0.8}Sr_{0.2})_{0.95}Cr_{0.5}Fe_{0.5}O_{3-δ} and 10Sc1CeSZ appears to sinters to full density in air at about 1400° C. to 1430° C.

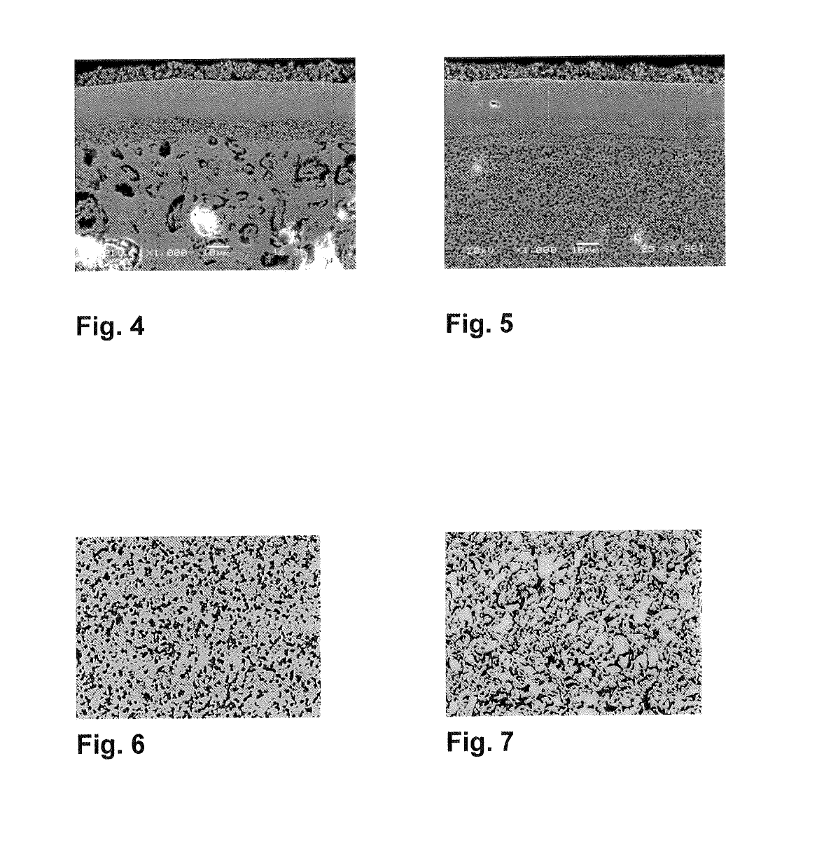

As shown in FIG. 5, the use fluorite structured ionic conducting material having bi-modal or multi-modal particle sizes of PMMA pore former produced oxygen transport membranes with both high porosity and a substantially uniform pore size distribution throughout the porous support layer. Helium leak rates were consistently lower for coated porous supports comprising 3YSZ with PMMA based pore forming materials (e.g., as low as 4×10⁻⁹ atm cc/sec) compared to helium leak rates for prior art coated porous supports comprising 3YSZ and walnut shell pore formers. FIGS. 4 and 5 are SEM micrographs (respectively 1000× magnification and 2000× magnification) which show greater pore uniformity and overall porous support layer microstructure uniformity when using a porous support comprised of fluorite structured ionic conducting material having bi-modal or multi-modal particle sizes 3YSZ with PMMA based pore forming material (FIG. 5) than a porous support comprised of 3YSZ and walnut shell pore formers (FIG. 4).

FIGS. 6 and 7 also show SEM micrographs (2000× magnification) of a porous support microstructure comprising a single average particle size 3YSZ material with PMMA based pore forming material of 1.5 micron particle size (FIG. 6) and a porous support comprising 3YSZ having different (e.g., bi-modal or multi-modal) average particle sizes (FIG. 7). Both porous support microstructure shown in FIGS. 6 and 7 exhibited higher strength, lower creep, and improved diffusion efficiency compared to a 3YSZ porous support having a single average particle size 3YSZ particle size and larger size walnut shell pore formers (see FIG. 4).

It has also been observed that the disclosed porous support layers 12, 12′, 12″ may have a permeability of between about 0.25 Darcy and about 0.5 Darcy. Standard procedures for measuring the permeability of a substrate in terms of Darcy number are outlined in ISO 4022. Porous support layers 12, 12′, 12″ also may have a thickness of between about 0.5 mm and about 4 mm and an average pore size diameter of no greater than about 50 microns. Additionally, the porous support layers also have catalyst particles 18 located within pores 20, 20′, 20″ and can be adjacent to the intermediate porous layer for purposes of also promoting combustible substance oxidation. The presence of the catalyst particles both within the intermediate porous layer and within the porous support layer provides enhancement of oxygen flux and therefore generation of more heat via combustion that can be obtained by either providing catalyst particles within solely the intermediate porous layer or the porous support layer alone. It is to be noted that to a lesser extent, catalyst particles can also be located in region of the pores that are more remote from the intermediate porous layer, and therefore do not participate in promoting fuel oxidation. However, the bulk of catalyst in a composite oxygen transport element can be located in the intermediate porous layer and within the pores adjacent or proximate to the intermediate porous layer.

In forming a composite oxygen transport membrane element, the porous support 12, 12′,12″ is first formed in a manner known in the art and as set forth in the references discussed above. For example, standard ceramic extrusion techniques can be employed to produce a porous support layer or structure in a tube configuration in a green state and then subjected to a bisque firing at 1050° C. for about 4 hours to achieve reasonable strength for further handling. After bisque firing, the resulting tube can be checked or tested for targeted porosity, strength, creep resistance and, most importantly, diffusivity characteristics. Alternatively, a freeze cast supporting structure could be formed as discussed in “Freeze-Casting of Porous Ceramics: A Review of Current Achievements and Issues” (2008) by Deville, pp. 155-169.

### EXAMPLE

The Example is given by way of illustration only and does not limit the scope of the present invention as defined in the appended claims. The Example demonstrates the formation of an oxygen transport membrane in accordance with an illustrative, non-limiting embodiment.

After forming the green tube, intermediate porous layer 14 is then formed. A mixture of about 34 grams of powders having electronic and ionic phases, LSCMV and 10Sc1YSZ, respectively, is prepared so that the mixture contains generally equal proportions by volume of LSCMV and 10Sc1YSZ. Prior to forming the mixture, the catalyst particles, such as CGO, are incorporated into the electronic phase LSCMV by forming deposits of such particles on the electronic phase, for example, by precipitation. However, in a particular embodiment the catalyst particles are formed within the intermediate porous layer by wicking a solution containing catalyst precursors through the porous support layer towards the intermediate porous layer after application of the membrane active layers as described in more detail below. As such, there is no requirement to deposit particles of catalyst on the electronic phase. The electronic phase particles are each about 0.3 microns prior to firing and the catalyst particles are about 0.1 microns or less and are present in a ratio by weight of about 10 wt %. To the mixture, 100 grams of toluene, 20 grams of the binder of the type previously described, and 400 grams of 1.5 mm diameter YSZ grinding media are added. The mixture is then milled for about 6 hours to form a slurry (D₅₀ of about 0.34 μm). About 6 grams of carbon black having a particle size of about D₅₀=0.8 μm is then added to the slurry and milled for additional 2 hours. An additional 10 grams of toluene and about 10 grams of additional binder is added to the slurry and mixed for between about 1.5 and about 2 hours. The inner wall of the green tube formed above is then coated by pouring the slurry, holding once for about 5 seconds and pouring out the residual back to the bottle. The coated green tube is then dried and fired at 850° C. for 1 hour in air.

The dense layer 10 is then applied. A mixture weighing about 40 grams is prepared that contains the same powders as used in forming the intermediate porous layer, discussed above, except that the ratio between LSCMV and 10Sc1YSZ is about 40/60 by volume, 2.4 grams of cobalt nitrate {Co(NO₃)₂.6H₂O}, 95 grams of toluene, 5 grams of ethanol, 20 grams of the binder previously described, and 400 grams of 1.5 mm diameter YSZ grinding media are then added to the mixture, and the same is milled for about 10 hours to form a slurry (D₅₀˜0.34 μm). About 10 grams of toluene and about 10 grams of binder are added to the slurry and mixed for about 1.5 and about 2 hours. The inner wall of the tube is then coated by pouring the slurry, holding once for about 10 seconds and pouring out the residual back to the bottle. The coated green tube is then stored dry prior to firing the layers in a controlled environment.

The coated green tube is then placed on a C-setter in a horizontal tube furnace and porous alumina tubes impregnated with chromium nitrate are placed close to the coated tube to saturate the environment with chromium vapor. The tubes are heated in static air to about 800° C. for binder burnout and, if necessary, the sintering environment is switched to an atmosphere of a saturated nitrogen mixture (nitrogen and water vapor) that contains about 4 percent by volume of hydrogen to allow the vanadium-containing electronic conducting perovskite structured materials to properly sinter. The tube is held at about 1350° C. to 1430° C. for about 8 hours and then cooled in nitrogen to complete the sintering of the materials. The sintered tube is then checked for leaks wherein the helium leak rates should be lower than 10⁻⁷ Pa.

Surface exchange layer 16 is then applied. A mixture of powders is prepared that contains about 35 g of equal amounts of ionic and electronic phases having chemical formulas of Zr_{0.80}Sc_{0.19}Y_{0.02}O_{2-δ} and La_{0.8}Sr_{0.2}FeO_{3-δ}, respectively. To this mixture, about 100 grams of toluene, 20 grams of the binder identified above, about 400 grams of 1.5 mm diameter YSZ grinding media are added and the resultant mixture is milled for about 14 hours to form a slurry (D₅₀˜0.4 μm). About six grams of carbon black are added to the slurry and milled for additional 2 hours. A mixture of about 10 grams of toluene and about 10 grams of the binder are then added to the slurry and mixed for between about 1.5 and about 2 hours. The inner wall of the tube is then coated by pouring the slurry, holding twice for about 10 seconds and then pouring out the residual back to the bottle. The coated tube is then dried and fired at 1100° C. for two hours in air.

The structure formed in the manner described above is in a fully sintered state and the catalyst is then further applied by wicking a solution containing catalyst precursors in the direction of arrowhead B at the side of the porous support opposite to the intermediate porous layer. The solution can be an aqueous metal ion solution containing about 20 mol % Gd(NO₃)₃ and 80 mol % Ce(NO₃)₃. A pressure can be established on the side of the porous support layer to assist in the infiltration of the solution. In addition, the pores can first be evacuated of air using a vacuum to further assist in wicking of the solution and reduce the likelihood of trapped air in the pores preventing wicking of the solution all the way through the porous support layer to the intermediate porous layer. The resulting composite oxygen transport membrane 1 in such state can be directly placed into service or further fired prior to being placed into service so that the catalyst particles, in this case Ce_{0.8}Gd_{0.2}O_{2-δ} are formed in the porous support layer adjacent to the intermediate porous layer and as described above, within the intermediate porous layer itself. The firing to form Ce_{0.8}Gd_{0.2}O_{2-δ} would take place at a temperature of about 850° C. and would take about 1 hour to form the catalyst particles. Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Certain features, that are for clarity, described herein in the context of separate embodiments, may also be provided in combination in a single embodiment. Conversely, various features that are, for brevity, described in the context of a single embodiment, may also be provided separately or in a subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

Although the present invention has been described with reference to particular embodiments, as will occur to those skilled in the art, changes and additions to such embodiment can be made without departing from the scope of the present invention as set forth in the appended claims.

1. A porous support layer comprising a fluorite structured ionic conducting material having a porosity of greater than 20 percent and a microstructure exhibiting substantially uniform pore size distribution throughout the porous support layer for a composite oxygen transport membrane, wherein the porous support layer is formed from a mixture comprising the fluorite structured ionic conducting material having bi-modal or multi-modal particle sizes or from a mixture comprising a polymethyl methacrylate based pore forming material and the fluorite structured ionic conducting material, the polymethyl methacrylate based pore forming material, the fluorite structured ionic conducting material, or both materials having bi-modal or multi-modal particle sizes.

2. A porous support layer of claim 1, wherein the fluorite structured ionic conducting material comprises a stabilized zirconia.

3. A porous support layer of claim 1, wherein the fluorite structured ionic conducting material comprises a yttria stabilized zirconia.

4. A porous support layer of claim 3 wherein the fluorite structured ionic conducting material is 3 mol % Y stabilized zirconia.

5. A composite oxygen transport membrane, the composite oxygen transport membrane comprising:
a porous support layer of claim 4;
an intermediate porous layer capable of conducting oxygen ions and electrons to separate oxygen from an oxygen-containing feed, the intermediate porous layer adjacent to the porous support layer and comprising a mixture of a fluorite structured ionic conductive material and an electrically conductive material to conduct the oxygen ions and electrons, respectively;
a dense layer capable of conducting oxygen ions and electrons to separate oxygen from an oxygen-containing feed, the dense layer adjacent to the intermediate porous layer and comprising a mixture of a fluorite structured ionic conductive material and electrically conductive materials to conduct the oxygen ions and electrons, respectively; and
catalyst particles located in pores of the porous support layer and intermediate porous layer, the catalyst particles containing a catalyst selected to promote oxidation of a combustible substance in the presence of the separated oxygen transported through the dense layer and the intermediate porous layer to the porous support layer.

6. The composite oxygen transport membrane of claim 5, wherein:
the intermediate porous layer contains a mixture of about 60 percent by weight of (LaᵤSrᵥCe₁₋ᵤ₋ᵥ)_{w}CrₓM_{y}V_{z}O_{3-δ} where u is from 0.7 to 0.9, v is from 0.1 to 0.3 and (1-u-v) is greater than or equal to zero, w is from 0.94 to 1, x is from 0.5 to 0.77, M is Mn or Fe, y is from 0.2 to 0.5, z is from 0 to 0.03, and x+y+z=1, with the remainder Zr_{x′}Sc_{y′}A_{z′}O_{2-δ}, where y′ is from 0.08 to 0.3, z′ is from 0.01 to 0.03, x′+y′+z′=1, and A is Y or Ce or mixtures of Y and Ce, and the intermediate porous layer has a thickness of between 10 microns and 40 microns, and a porosity of between 25 percent and 40 percent;
the dense layer contains a mixture of about 40 percent by weight of (LaᵤSrᵥCe_{1-u-z})_{w}CrₓM_{y}V_{z}O_{3-δ} where u is from 0.7 to 0.9, v is from 0.1 to 0.3 and (1-u-v) is greater than or equal to zero, w is from 0.94 to 1, x is from 0.5 to 0.77, M is Mn or Fe, y is from 0.2 to 0.5, z is from 0 to 0.03, and x+y+z=1, with the remainder Zr_{x′}Sc_{y′}A_{z′}O_{2-δ}, where y′ is from 0.08 to 0.3, z′ is from 0.01 to 0.03, x′+y′+z′=1, and A is Y or Ce or mixtures of Y and Ce, and the dense layer has a thickness of between 10 microns and 50 microns;
the porous surface exchange layer is formed from a mixture of about 50 percent by weight of (La_{x′″}Sr_{1-x′″})_{y′″}MO_{3-δ}, where x″′ is from 0.2 to 0.9, y″′ is from 0.95 to 1, M is Mn or Fe, with the remainder Zrₓ^{iv}Sc_{y}^{iv}A_{z}^{iv}O_{2-δ}, where y^{iv} is from 0.08 to 0.3, z^{iv} is from 0.01 to 0.03, x^{iv}+y^{iv}+z^{iv}=1, and A is Y, Ce or mixtures of Y and Ce; and
the porous support layer has a thickness of between 0.5 mm and 4 mm

7. A porous support layer of claim 1, wherein the fluorite structured ionic conducting material has at least 30 weight percent of particles having a particle size greater than 2.0 microns.

8. A porous support layer of claim 1, wherein the fluorite structured ionic conducting material is formed by mixing a first powder having a median particle size diameter of between 0.3 microns and 1.5 microns and a second powder having a median particle size diameter of between 2.0 microns and 6.0 microns.

9. A porous support layer of claim 6, wherein the fluorite structured ionic conducting material has at least 90 weight percent of particles having a particle size below 8.0 microns.

10. A porous support layer of claim 1, having a thickness of between 0.5 mm and 4 mm.

11. A porous support layer of claim 1, having a porosity of between about 20 percent and 40 percent.

12. A porous support layer of claim 1, wherein the fluorite structured ionic conducting material has bi-modal or multi-modal particle sizes.

13. A process of forming a composite oxygen transport membrane comprising:
fabricating a porous support layer comprised of an fluorite structured ionic conducting material, the fabricating step including pore forming enhancement step such that the porous support layer has a porosity of greater than about 20 percent and a microstructure exhibiting substantially uniform pore size distribution throughout the porous support layer;
applying an intermediate porous layer on the porous support layer, the intermediate porous layer capable of conducting oxygen ions and electrons to separate oxygen from an oxygen-containing feed, the intermediate porous layer comprising a mixture of a fluorite structured ionic conductive material and electrically conductive materials to conduct the oxygen ions and electrons, respectively;
applying a dense layer on the intermediate porous layer, the dense layer capable of conducting oxygen ions and electrons to separate oxygen from an oxygen-containing feed, the dense layer also comprising a mixture of a fluorite structured ionic conductive material and electrically conductive materials to conduct the oxygen ions and electrons, respectively; and
introducing catalyst particles or a solution containing precursors of the catalyst particles to the porous support layer and intermediate porous layer, the catalyst particles containing a catalyst selected to promote oxidation of a combustible substance in the presence of the separated oxygen transported through the dense layer and the intermediate porous layer to the porous support layer, wherein the pore forming enhancement process comprises use of bi-modal or multi-modal particle sizes of the fluorite structured ionic conducting material of the porous support layer.
